(19) United States
(12) Patent Application Publication
(10) Pub. No.: US 2023/0120816 A1
(43) Pub. Date: Apr. 20, 2023

(54) POWER SAVING MODES OF WIRELESS CHARGERS

(71) Applicant: HEWLETT-PACKARD DEVELOPMENT COMPANY, L.P., Spring, TX (US)

(72) Inventors: Yen-Chi CHEN, Taipei City (TW); Chi-Chu CHEN, Taipei City (TW); Hui-Jen TSENG, Taipei City (TW); Wen-Hua NI, Taipei City (TW); Jun-Hung CHOU, Taipei City (TW); Cheng-Kai CHEN, Taipei City (TW); Cheng-Han TSAI, Taipei City (TW)

(21) Appl. No.: 17/504,413

(22) Filed: Oct. 18, 2021

(51) Int. Cl. H02J 50/10; H02J 7/00; H02J 50/80

(52) U.S. Cl. CPC H02J 50/10; H02J 7/0048; H02J 50/80; G06F 3/03545

(57) ABSTRACT

In some examples, an electronic device includes a wireless charger, a detector, and a controller. The controller is to detect a peripheral device via the detector and, in response to detecting the peripheral device via the detector, determine an operation mode of the wireless charger, the operation mode including a power saving mode, a standby mode, and a charging mode.

### BACKGROUND

Electronic devices such as desktops, laptops, notebooks, tablets, and smartphones interact with peripheral devices that enable data input into the electronic devices, that receive data from the electronic devices, or a combination thereof. A peripheral device is a stylus, a mouse, a keyboard, a touchpad, or a combination thereof, for instance. Some peripheral devices include batteries that are rechargeable by wireless chargers of the electronic devices.

### BRIEF DESCRIPTION OF THE DRAWINGS

Various examples are described below referring to the following figures.

FIG. 1 is a block diagram depicting a system including an electronic device having a wireless charger with a power saving mode, in accordance with various examples.

FIG. 2 is a flow diagram depicting a method for adjusting an operation mode of a wireless charger, in accordance with various examples.

FIG. 3 is a block diagram depicting a system including an electronic device having a wireless charger with a power saving mode, in accordance with various examples.

FIG. 4 is a flow diagram depicting a method for adjusting an operation mode of a wireless charger, in accordance with various examples.

FIG. 5 is a flow diagram depicting a method for adjusting an operation mode of a wireless charger, in accordance with various examples.

FIGS. 6A and 6B are block diagrams depicting a system including an electronic device having a wireless charger with a power saving mode, in accordance with various examples.

FIGS. 7A, 7B, and 7C are schematic diagrams depicting a peripheral device including a trigger for adjusting an operation mode of a wireless charger, in accordance with various examples.

FIG. 8 is a flow diagram depicting a method for adjusting an operation mode of a wireless charger, in accordance with various examples.

FIG. 9 is a flow diagram depicting a method for adjusting an operation mode of a wireless charger, in accordance with various examples.

### DETAILED DESCRIPTION

As described above, some electronic devices include wireless chargers to recharge batteries of peripheral devices. A stylus is one such peripheral device. The stylus enables writing on a touchscreen of an electronic device, drawing on a touchpad of the electronic device, or selecting an option or a keyboard key presented on a display panel of the electronic device, for instance. To wirelessly communicate with the electronic device, the stylus includes a wireless transceiver and a battery to provide power to the wireless transceiver and other hardware components of the stylus. The wireless charger of the electronic device charges the stylus battery when the stylus is within a sensing range of the electronic device. The sensing range, as used herein, indicates that the stylus is within a threshold distance to the electronic device. To monitor for the stylus, the electronic device maintains the wireless charger in a standby mode. The standby mode, as used herein, is an operation mode of the wireless charger in which the electronic device provides an amount of power to components of the wireless charger utilized for detection of the peripheral device. While the standby mode of the wireless charger utilizes less power than a charging mode of the wireless charger, the standby mode adds to an overall power consumption of the electronic device. The charging mode, as used herein, is an operation mode of the wireless charger in which the wireless charger provides power to the peripheral device. The charging mode includes a quick charge mode, a normal charge mode, and a trickle charge mode for instance. The quick charge mode causes the wireless charger to provide more power than the normal charge mode, for instance.

This description describes electronic devices that utilize power saving modes of wireless chargers to reduce power consumption. A power saving mode, as used herein, is an operation mode of the wireless charger that utilizes less power than the standby mode and the charging mode. In some examples, during the power saving mode, the electronic device powers off the wireless charger. In other examples, the power saving mode supplies an amount of power to components of the wireless charger to reduce a power up time of the wireless charger. When the peripheral device is beyond the sensing range of the electronic device, indicates a battery charge exceeds (e.g., is greater than or equal to) a capacity threshold, or a combination thereof, the electronic device causes the wireless charger to enter the power saving mode. The capacity threshold, as used herein, indicates the battery is charged to a level that indicates full capacity of the battery or that is within a programmed amount of the full capacity of the battery. The electronic device monitors, via a detector, for the peripheral device to be within the sensing range of the electronic device. In some examples, the detector is a sensor, such as a Hall effect sensor, a Hall effect switch, or a reed switch. In other examples, the detector is a switch that engages upon contact and disengages upon discontinuation of the contact, such as a momentary switch, a push button switch, or any other suitable non-latching switch. In response to detecting the peripheral device within the sensing range of the electronic device, the electronic device causes the wireless charger to operate in the standby mode. While in the standby mode, the electronic device determines whether the peripheral device is compatible with the wireless charger. In response to determining that the peripheral device is compatible with the wireless charger, the electronic device causes the wireless charger to operate in the charging mode. In some examples, the electronic device determines a charge level of the battery of the peripheral device. In response to the charge level having a value below a charge threshold, the electronic device causes the wireless charger to operate in the quick charge mode. In response to the charge level having a value that is equivalent to or above the charge threshold, the electronic device causes the wireless charger to operate in the normal charge mode. In response to the electronic device detecting that the peripheral device is beyond the sensing range of the electronic device, that a battery charge of the peripheral device exceeds the capacity threshold, or a combination thereof, the electronic device causes the wireless charger to enter the power saving mode.

By utilizing the power saving mode of the wireless charger, the electronic device reduces the power consumption of the electronic device when the peripheral device is charged to the capacity threshold, beyond the sensing range of the electronic device, or a combination thereof. By utilizing detectors that operate as passive components until the peripheral device is within the sensing range of the electronic device, the electronic device reduces the power consumption of the electronic device.

In some examples in accordance with the present description, an electronic device is provided. The electronic device includes a wireless charger, a detector, and a controller. The controller is to detect a peripheral device via the detector and, in response to detecting the peripheral device via the detector, determine an operation mode of the wireless charger, the operation mode including a power saving mode, a standby mode, and a normal charge mode.

In other examples in accordance with the present description, an electronic device is provided. The electronic device includes a wireless charger, a sensor, and a controller. The controller causes the wireless charger to enter a power saving mode, detect a signal via the sensor, and, in response to detecting the signal via the sensor, cause the wireless charger to enter a standby mode.

In yet other examples in accordance with the present description, an electronic device is provided. The electronic device includes a wireless charger, a switch, and a controller. The controller is to detect a state of the switch. In response to detecting that the state of the switch indicates a first state, the controller causes the wireless charger to enter a power saving mode, and, in response to detecting that the state of the switch indicates a second state, the controller causes the wireless charger to enter a standby mode.

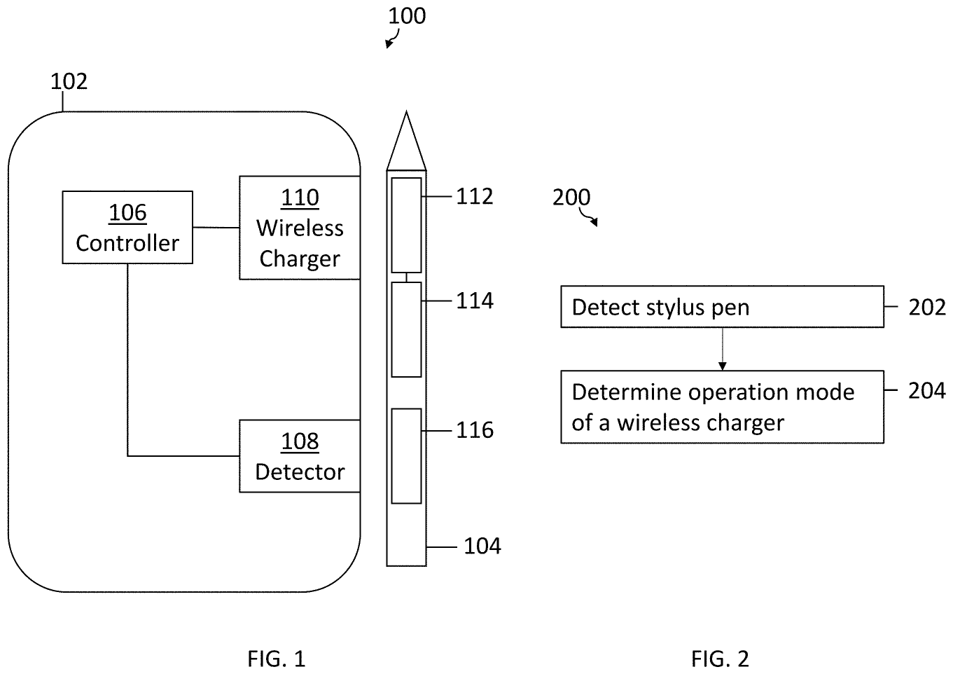

Referring now to FIG. 1, a block diagram of a system 100 including an electronic device 102 that has a wireless charger 110 with a power saving mode is depicted, in accordance with various examples. The system 100 includes the electronic device 102 and a peripheral device 104. The electronic device 102 is a desktop, a laptop, a notebook, a tablet, a smartphone, or any other suitable computing device that interacts with the peripheral device 104, for example. The peripheral device 104 is an input device, an output device, or a combination thereof, from which the electronic device 102 receives input data, to which the electronic device 102 outputs data, or a combination thereof. The peripheral device 104 is a stylus, a mouse, a keyboard, a touchpad, or a combination thereof, for example.

The electronic device 102 houses a controller 106, a detector 108, and the wireless charger 110. The controller 106 is a microprocessor, a microcomputer, a microcontroller, a programmable integrated circuit, a programmable gate array, or other suitable device for managing operations of components of the electronic device 102. The controller 106 is an embedded controller of the wireless charger 110, for example. In another example, the controller 106 is an embedded controller for multiple subsystems of the electronic device 102. The detector 108 is a circuit that detects when the peripheral device 104 is within a sensing range of the detector 108. The detector 108 is a switch, a sensor, or any other component or circuit for detecting proximity. The detector 108 detects the proximity by detecting a magnetic field or a change in the magnetic field or by determining another device is in contact with the detector, for example. The detector 108 is a Hall effect sensor, a Hall effect switch, a reed switch, or a combination thereof, for example. In another example, the detector 108 detects the proximity in response to contact with the peripheral device 104. The detector 108 is a momentary switch, a push button switch, or another non-latching switch, for example. The detector 108 may be partially or fully housed in a chassis of the electronic device 102 or may be located on an external surface of the chassis. The wireless charger 110 is a circuit that provides power to the peripheral device 104 that is wirelessly coupled to the wireless charger 110 by utilizing electromagnetic waves, radio waves, or a combination thereof to transfer energy to the devices. The wireless charger 110 operates according to a specification or standard, such as the AirFuel Alliance standard, the Qi standard of the Wireless Power Consortium (WPC), a standard for Near Field Communication (NFC), or any other specification or standard that provides operating parameters for the wireless charger 110.

The peripheral device 104 includes a wireless transceiver 112, a battery 114 and a trigger 116. The wireless transceiver 112 is a circuit for transmitting and receiving signals. The wireless transceiver 112 operates according to a specification or standard that provides operating parameters for the wireless transceiver 112. The signals are BLUETOOTH® signals, WI-FI® signals, or a combination thereof, for example. The battery 114 is a rechargeable battery. The trigger 116 is a passive component, a circuit, or combination thereof to indicate to the electronic device 102 that the peripheral device 104 is within a sensing range of the electronic device 102. The trigger 116 is a magnet, an electromagnet, a circuit that generates a magnetic field, or a combination thereof, for example. In another example, the trigger 116 is a component to engage a switch.

While not explicitly shown, the electronic device 102 includes a network interface, a video adapter, a sound card, local buses, multiple peripheral devices (e.g., a stylus, a keyboard, a mouse, a touchpad, a speaker, a microphone, a headset, a display device, etc.), or a combination thereof. While the detector 108 and the wireless charger 110 are shown as an integrated detector and an integrated wireless charger, in other examples, the detector 108, the wireless charger 110, or a combination thereof, are coupled to the electronic device 102 via a wired connection (e.g., Universal Serial Bus (USB)) or a wireless connection (e.g., WI-FI®, BLUETOOTH®).

In various examples, the controller 106 couples to the detector 108 and the wireless charger 110. The detector 108 detects that the peripheral device 104 is within a sensing range of the detector 108. The detector 108 detects the trigger 116, for example. In some examples, responsive to the detection of the peripheral device 104, the controller 106 determines that the peripheral device 104 is wirelessly coupled to the electronic device 102. Responsive to the detection of the peripheral device 104, the controller 106 causes the wireless charger 110 to operate in the charging mode. In some examples, the controller 106 causes a power switch circuit to switch on to cause the wireless charger 110 to operate in the charging mode. During the charging mode, the wireless charger 110 transmits power. For example, the controller 106 causes transmission of an alternating current through an inductive coil of the wireless charger 110 to create a magnetic field. The magnetic field generates an alternating current in an induction coil (not explicitly shown) of the peripheral device 104. The induction coil (not explicitly shown) of the peripheral device 104 is coupled to a rectifier (not explicitly shown) that converts the alternating current to a direct current. The rectifier (not explicitly shown) is coupled to the battery 114, and the direct current charges the battery 114. In various examples, the detector 108 detects that the peripheral device 104 is no longer within the sensing range of the detector 108. The detector 108 no longer detects the trigger 116, for example. Responsive to the detector 108 no longer detecting the peripheral device 104, the controller 106 causes the wireless charger 110 to operate in the power saving mode.

Referring now to FIG. 2, a flow diagram of a method 200 for adjusting the operation mode of a wireless charger (e.g., the wireless charger 110) is depicted, in accordance with various examples. The method 200 is performed by the electronic device 102, for example. The method 200 includes detecting a peripheral device (e.g., the peripheral device 104) (202). The method 200 also includes determining an operating mode of the wireless charger (204).

In various examples, a controller (e.g., the controller 106) of the electronic device detects that the peripheral device is within a sensing range via a detector (e.g., the detector 108) of the electronic device 102. The detector detects a trigger (e.g., the trigger 116) of the peripheral device, for example. In response to detecting the peripheral device via the detector, the controller determines an operation mode of the wireless charger. The operation mode may be the power saving mode, the standby mode, or the charging mode, for example.

In some examples, the controller causes the wireless charger to operate in the standby mode. In various examples, the controller causes a power switch circuit to switch on to cause the wireless charger to operate in the standby mode. During the standby mode, the controller determines whether the peripheral device is compatible with the wireless charger. For example, the controller receives a signal from the peripheral device. The controller determines whether the peripheral device is compatible with the wireless charger based on the data of the signal. Responsive to a determination that the peripheral device is not compatible with the wireless charger, the controller causes the wireless charger to operate in the power saving mode. In various examples, the controller causes a power switch circuit to switch off to cause the wireless charger to operate in the power saving mode.

In other examples, as described above with respect to FIG. 1, the controller causes the wireless charger to operate in the charging mode. For example, the controller determines a charge level of a battery (e.g., the battery 114) of the peripheral device. In some examples, the controller receives a signal from the peripheral device that includes the charge level. In response to the charge level being less than the charge threshold, the controller causes the wireless charger to operate in the quick charge mode. In response to the charge level being greater than the charge threshold, the controller causes the wireless charger to operate in the normal charge mode. Being greater than the charge threshold, as used herein, includes values that are equivalent to or greater than the charge threshold. In various examples, in response to the controller detecting that the charge level of the battery exceeds the capacity threshold, the controller causes the wireless charger to enter the trickle charge mode. In other examples, in response to the controller detecting that the charge level of the battery exceeds the capacity threshold, the controller causes the wireless charger to enter the power saving mode.

In various examples, a manufacturer of the wireless charger, the electronic device, the peripheral device, or a combination thereof, specifies the charge threshold, the capacity threshold, or a combination thereof, at a time of manufacture. In some examples, a user of the electronic device, specifies the charge threshold, the capacity threshold, or a combination thereof. The user may utilize a graphical user interface (GUI) to specify the charge threshold, the capacity threshold, or a combination thereof, for example.

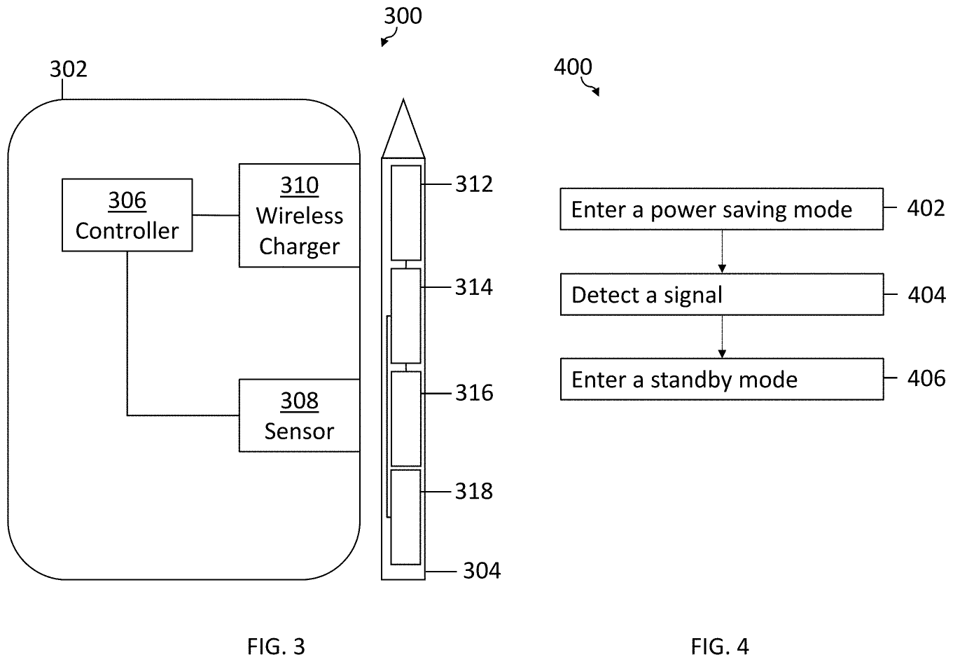

Referring now to FIG. 3, a block diagram of a system 300 including an electronic device 302 that has a wireless charger 310 with a power saving mode is depicted, in accordance with various examples. The system 300 is the system 100, for example. The system 300 includes the electronic device 302 and a peripheral device 304. The electronic device 302 is the electronic device 102, for example. The peripheral device 304 is the peripheral device 104, for example.

The electronic device 302 includes a controller 306, a sensor 308, and the wireless charger 310. The controller 306 is the controller 106, for example. The sensor 308 is the detector 108, for example. The sensor 308 is any suitable component or circuit for detecting proximity, for example. The sensor 308 detects the proximity by detecting a change in a magnetic field, for example. The wireless charger 310 is the wireless charger 110, for example.

In some examples, the controller 306 couples to the sensor 308 and the wireless charger 310. In various examples, the sensor 308 is a Hall effect sensor, a reed switch, or a combination thereof.

The peripheral device 304 includes a wireless transceiver 312, a controller 314, a battery 316, and a trigger 318. The wireless transceiver 312 is the wireless transceiver 112, for example. The controller 314 is a microprocessor, a microcomputer, a microcontroller, a programmable integrated circuit, a programmable gate array, or other suitable device for managing operations of the peripheral device 304. The battery 316 is the battery 114, for example. The trigger 318 is the trigger 116, for example.

In some examples, the controller 314 couples to the wireless transceiver 312, the battery 316, and the trigger 318. In various examples, the trigger 318 is an electromagnet. Responsive to the controller 314 determining that a charge level of the battery 316 is below the charge threshold, the controller 314 causes transmission of a high voltage signal to the trigger 318. The high voltage signal causes the trigger 318 to generate a magnetic field. Responsive to the controller 314 determining that the charge level of the battery 316 exceeds the charge threshold, the controller 314 causes transmission of a low voltage signal to the trigger 318. The low voltage signal causes the trigger 318 to stop generating the magnetic field.

As described above with respect to FIG. 2, in various examples, the controller 306 detects that the peripheral device 304 is within a sensing range via the sensor 308. The sensor 308 detects the magnetic field of the trigger 318, for example. In response to detecting the magnetic field via the sensor 308, the controller 306 determines the operation mode of the wireless charger 310. In some examples, in response to detecting no magnetic field via the sensor 308, the controller 306 causes the wireless charger 310 to operate in the power saving mode.

In various examples, in response to detecting the magnetic field via the sensor 308, the controller 306 causes the wireless charger 310 to operate in the standby mode. During the standby mode, the controller 306 determines whether the peripheral device 304 is compatible with the wireless charger 310. For example, the controller 306 causes a wireless transceiver (not explicitly shown) of the electronic device 302 to transmit a signal to the peripheral device 304. The signal includes data that is in a format specified by a communication standard associated with the wireless charger 310, for example. Responsive to the signal, the controller 314 causes the wireless transceiver 312 to transmit another signal. The another signal includes data that is in a format specified by the communication standard associated with the wireless charger 310, for example. Responsive to a determination based on the another signal that the peripheral device 304 is not compatible with the wireless charger 310, the controller 306 causes the wireless charger 310 to operate in the power saving mode. In some examples, responsive to a determination that the another signal is not received within a specified time period after transmission of the signal, the controller 306 causes the wireless charger 310 to operate in the power saving mode. Responsive to a determination based on the another signal that the peripheral device 304 is compatible with the wireless charger 310, the controller 306 causes the wireless charger 310 to operate in the charging mode.

As described above with respect to FIG. 2, to cause the wireless charger 310 to operate in the charging mode, the controller 306 determines the charge level of the battery 316. In various examples, the controller 306 determines the charge level based on a strength of the magnetic field generated by the trigger 318. For example, responsive to the controller 314 determining that a charge level of the battery 316 is below a first charge threshold, the controller 314 causes transmission of a high voltage signal to the trigger 318. The high voltage signal causes the trigger 318 to generate a magnetic field having a first strength. Responsive to the controller 314 determining that the charge level of the battery 316 exceeds the first charge threshold and is below a second charge threshold, the controller 314 causes transmission of a lower voltage signal to the trigger 318. The lower voltage signal causes the trigger 318 to generate the magnetic field having a second strength. In some examples, in response to the magnetic field having the first strength, the controller 306 causes the wireless charger 310 to operate in the quick charge mode. In response to the magnetic field having the second strength, the controller 306 causes the wireless charger 310 to operate in the normal charge mode. In other examples, in response to the strength of the magnetic field being below an intensity threshold, the controller 306 causes the wireless charger 310 to operate in the quick charge mode. In response to the strength of the magnetic field being greater than the intensity threshold, the controller 306 causes the wireless charger 310 to operate in the normal charge mode. In various examples, a manufacturer of the wireless charger 310, the electronic device 302, the peripheral device 304, or a combination thereof, specifies the first charge threshold, the second charge threshold, the intensity threshold, or a combination thereof, at a time of manufacture. In some examples, a user of the electronic device, specifies the first charge threshold, the second charge threshold, the intensity threshold, or a combination thereof. The user may utilize a GUI to specify the first charge threshold, the second charge threshold, the intensity threshold, or a combination thereof, for example.

By utilizing the power saving mode of the wireless charger 110, 310, the electronic device 102, 302 reduces the power consumption of the electronic device 102, 302 when the charge level of the peripheral device 104, 304 exceeds the capacity threshold, beyond the sensing range of the electronic device 102, 302, or a combination thereof. By utilizing the detector 108 or the sensor 308, which operate as passive components until the peripheral device 104, 304 is within the sensing range of the electronic device 102, 302, the electronic device 102, 302 reduces the power consumption of the electronic device 102, 302. Utilizing an electromagnet for the trigger 318 enables the electronic device 102, 302 to determine whether the charging mode for the wireless charger 110, 310 is the quick charge mode or the normal charge mode.

Referring now to FIG. 4, a flow diagram of a method 400 for adjusting the operation mode of a wireless charger (e.g., the wireless charger 110, 310) is depicted, in accordance with various examples. The method 400 is performed by the electronic device 102, 302, for example. The method 400 includes causing the wireless charger to enter the power saving mode (402). The method 400 also includes detecting a signal (404). Additionally, the method 400 includes causing the wireless charger to enter the standby mode in response to detecting the signal (406).

In various examples, a controller (e.g., the controller 106, 306) of the electronic device causes the wireless charger to enter the power saving mode. For example, the controller causes the wireless charger to enter the power saving mode in response to a sensor (e.g., the sensor 308) of the electronic device not detecting a peripheral device (e.g., the peripheral device 104, 304) is within the sensing range of the sensor, that the battery (e.g., the battery 114, 316) of the peripheral device exceeds the capacity threshold, or a combination thereof. In some examples, the wireless charger is powered off when in the power saving mode. The controller detects the signal via the sensor. For example, the sensor detects the signal generated by a trigger (e.g., the trigger 116, 318) of the peripheral device. In response to detecting the signal, the controller causes the wireless charger to enter the standby mode. In some examples, during the standby mode, the controller determines whether the peripheral device is compatible with the wireless charger. The controller determines whether the peripheral device is compatible with the wireless charger utilizing the techniques described above with respect to FIGS. 2 and 3, for example. Responsive to a determination that the peripheral device is not compatible with the wireless charger, the controller causes the wireless charger to operate in the power saving mode. In examples where the wireless charger is powered off during the power saving mode, the controller causes the wireless charger to power up (e.g., turn on) and enter the standby mode.

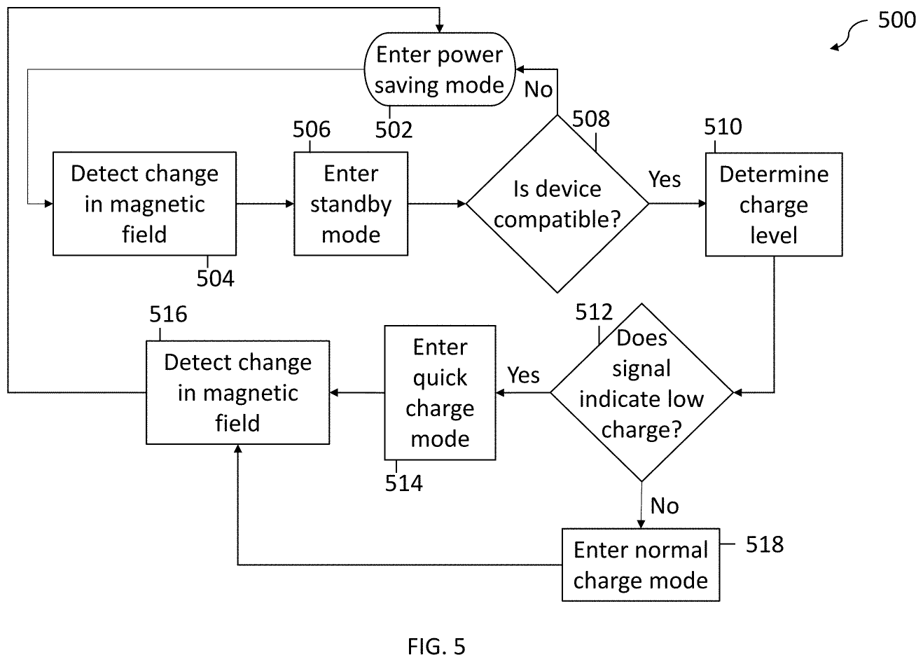

Referring now to FIG. 5, a flow diagram of a method 500 for adjusting the operation mode of a wireless charger (e.g., the wireless charger 110, 310) is depicted, in accordance with various examples. The method 500 is performed by the electronic device 102, 302, for example. The method 500 includes entering the power saving mode (502). The method 500 also includes detecting a change in a magnetic field (504). Additionally the method 500 includes entering the standby mode (506). At 508, the method 500 includes determining whether a peripheral device (e.g., the peripheral device 104, 304) is compatible with the wireless charger. Responsive to a determination that the peripheral device is not compatible with the wireless charger, the method 500 includes entering the power saving mode (502). Responsive to a determination that the peripheral device is compatible with the wireless charger, the method 500 includes determining a charge level of the peripheral device (510). At 512, the method 500 includes determining whether a signal received from the peripheral device indicates that the peripheral device has a low charge. Responsive to a determination that the peripheral device has a low charge, the method 500 includes entering a quick charge mode (514). Responsive to a determination that the peripheral device does not have a low charge, the method 500 includes entering a normal charge mode (518). Additionally, the method 500 includes detecting a change in the magnetic field (516). Responsive to the detection of the change in the magnetic field, the method 500 also includes entering the power saving mode (502).

In various examples, a controller (e.g., the controller 106, 306) of the electronic device performs some or all of the method 500. For example, the controller causes the wireless charger to enter the power saving mode. The controller detects a signal via a sensor (e.g., the detector 108, the sensor 308). The signal indicates a change in a magnetic field, for example. Responsive to detecting the signal, the controller causes the wireless charger to enter the standby mode. The controller determines whether the peripheral device is compatible with the wireless charger utilizing the techniques described above with respect to FIG. 3, for example. For example, the controller detects another signal via a wireless transceiver of the electronic device. In some examples, the wireless charger includes the wireless transceiver. In response to detecting the another signal, the controller determines whether the another signal indicates a low charge level of the peripheral device. In response to a determination that the another signal indicates that the charge level is below the charge threshold, the controller causes the wireless charger to enter a quick charge mode. In response to a determination that the another signal indicates that the charge level exceeds the charge threshold, the controller causes the wireless charger to enter a normal charge mode. In some examples, the controller detects a third signal via the wireless transceiver of the electronic device. The third signal indicates that the charge level of the battery of the peripheral device exceeds the capacity threshold. In other examples, the controller detects a third signal via the sensor. The third signal indicates that the peripheral device is no longer within sensing range of the sensor. In some examples, in response to detecting the third signal, the controller causes the wireless charger to enter the power saving mode. In other examples, in response to detecting the third signal, the controller causes the wireless charger to enter the trickle charge mode.

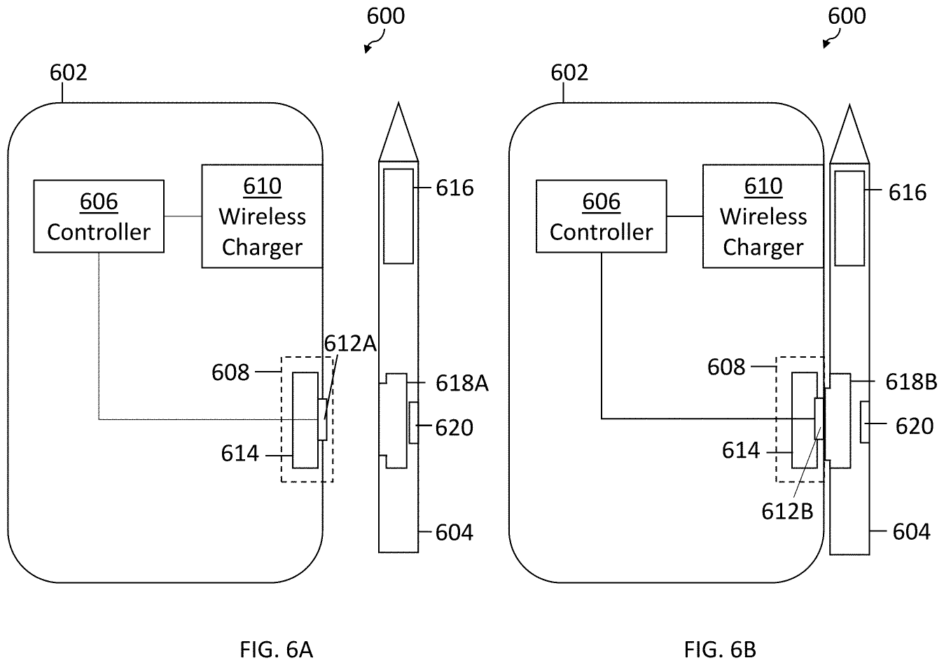

Referring now to FIGS. 6A and 6B, block diagrams of a system 600 including an electronic device 602 that has a wireless charger 610 with a power saving mode are depicted, in accordance with various examples. The system 600 includes the electronic device 602 and a peripheral device 604. The electronic device 602 is the electronic device 102, 302, for example. The peripheral device is the peripheral device 104, 304, for example. The electronic device 602 includes a controller 606, a detector 608, and the wireless charger 610. The controller 606 is the controller 106, 306 for example. The detector 608 is the detector 108, for example. The wireless charger 610 is the wireless charger 110, 310 for example. The detector 608 includes a switch 612 (e.g., the switch 612A, 612B) and a magnet 614. The switch 612 is any switch that engages upon contact and disengages upon discontinuation of the contact.

The peripheral device 604 includes a battery 616, a trigger 618 (e.g., the trigger 618A, 618B), and a magnet 620. The battery 616 is the battery 114, 316 for example. The trigger 618 is the trigger 116, for example. The trigger 618 has a magnetic body, for example. The magnet 620 is any suitable magnet that generates a magnetic field having a lower intensity than a magnetic field of the magnet 614. The trigger 618 and the magnet 620 are oriented such that the magnetic field of the magnet 620 attracts the trigger 618 toward the magnet 620.

In various examples, the controller 606 couples to the switch 612 and the wireless charger 610. Referring to FIG. 6A, the switch 612A is in a disengaged state. Responsive to the disengaged state, the controller 606 causes the wireless charger 610 to operate in the power saving mode. Referring to FIG. 6B, the switch 612B is in an engaged state. Responsive to the engaged state, the controller 606 causes the wireless charger 610 to operate in the standby mode or the charging mode.

In some examples, the switch 612 retracts into a slot of a chassis of the electronic device 602 when engaged by the trigger 618 of the peripheral device 604. In various examples, the slot is a ring that is of a same material as the switch 612. In other examples, the ring is of a different material than the switch 612. For example, the switch 612 is plastic and the ring is anodized aluminum. In various examples, the slot includes a coating to protect the chassis from wear responsive to contact with the trigger 618. In various examples, the chassis includes a coating to protect the chassis from wear responsive to contact with the peripheral device 604. For example, the chassis is coated in painted magnesium. In some examples, the coating of the slot and the coating of the chassis are different. In various examples, the trigger 618 includes a coating to protect the chassis. For example, the coating is a rubber material, a thermoplastic polyurethane material, a plastic material, or a combination thereof. In some examples, the coating of the trigger 618 covers a portion of the trigger 618. For example, the coating covers the portion of the trigger 618 that retracts into the peripheral device 604.

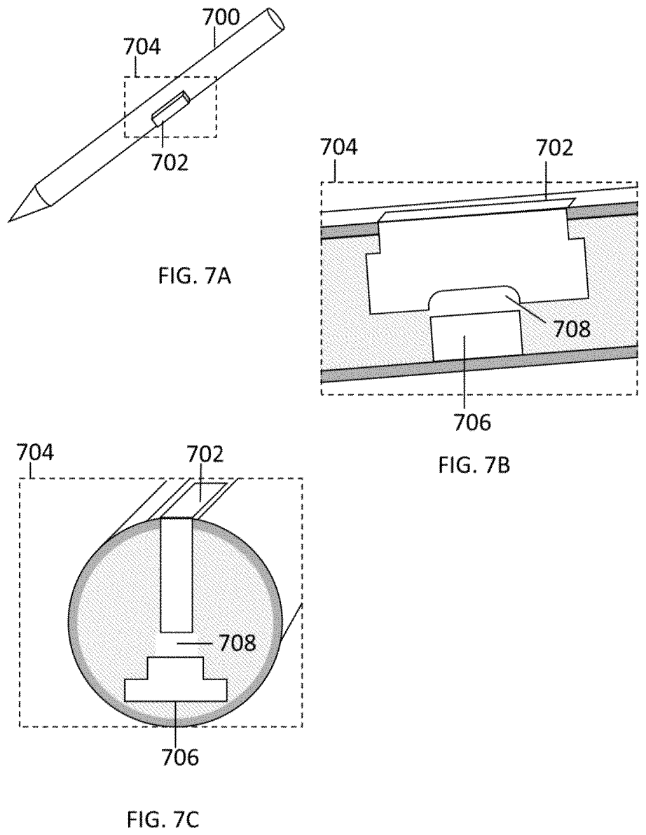

In some examples, the trigger 618 is a magnetic body. Responsive to movement of the peripheral device 604 beyond a magnetic field of the magnet 614, the magnet 620 causes the trigger 618 to retract within a chassis of the peripheral device 604, as described below with respect to FIGS. 7A-7C. In various examples, removal of pressure caused by contact of the peripheral device 604 with the switch 612, causes the switch 612 to enter the disengaged state. Responsive to movement of the peripheral device 604 within the magnetic field of the magnet 614, the magnet 614 causes the trigger 618 to exit the chassis of the peripheral device 604. The trigger 618 contacting the switch 612 causes the switch 612 to enter the engaged state.

Referring now to FIGS. 7A, 7B, and 7C, schematic diagrams of a peripheral device 700 including a trigger 702 for adjusting the operation mode of a wireless charger (e.g., the wireless charger 110, 310, 610) are depicted, in accordance with various examples. FIG. 7A depicts a schematic diagram of a full view of the peripheral device 700 that includes the trigger 702 highlighted in an area 704 of the peripheral device 700. The trigger 702 is the trigger 618, for example. FIG. 7B depicts a schematic diagram of a lengthwise cutaway view of the area 704. The area 704 includes the trigger 702, a magnet 706, and a cavity 708. The magnet 706 is the magnet 620, for example. FIG. 7C depicts a schematic diagram of a radial cutaway view of the area 704. The area 704 includes the trigger 702, the magnet 706, and the cavity 708.

As described above with respect to FIGS. 6A and 6B, in some examples, the trigger 702 is a magnetic body. Responsive to movement of the peripheral device 700 beyond a magnetic field of a magnet of an electronic device (e.g., the electronic device 102, 302, 602), the magnet 706 causes the trigger 702 to retract into the cavity 708 within a chassis of the peripheral device 700.

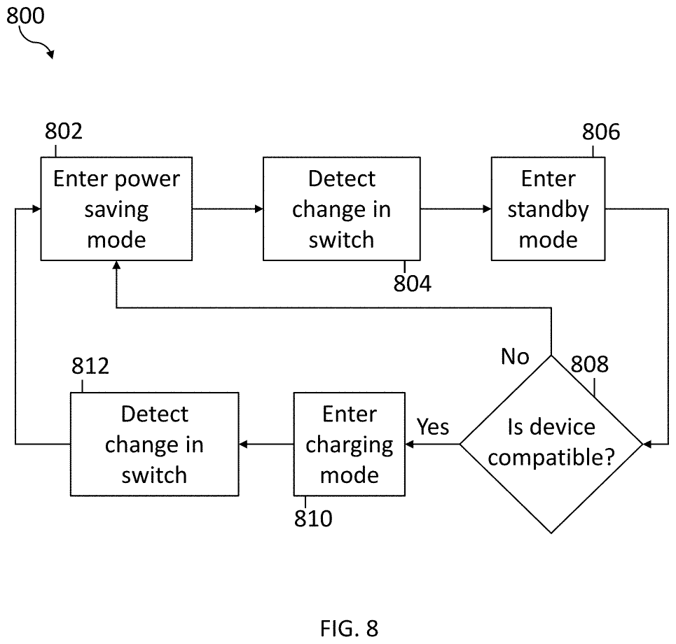

Referring now to FIG. 8, a flow diagram of a method 800 for adjusting the charging mode of a wireless charger (e.g., the wireless charger 110, 310, 610) is depicted, in accordance with various examples. The method 800 is performed by the electronic device 102, 302, 602, for example. The method 800 includes entering the power saving mode (802). The method 800 also includes detecting a change in a switch (e.g., the switch 612) (804). Additionally the method 800 includes entering the standby mode (806). At 808, the method 800 includes determining whether a peripheral device (e.g., the peripheral device 104, 304, 604, 700) is compatible with the wireless charger. Responsive to a determination that the peripheral device is not compatible with the wireless charger, the method 800 includes entering the power saving mode (802). Responsive to a determination that the peripheral device is compatible with the wireless charger, the method 800 includes entering a charging mode (810). Responsive to detecting a change in the switch at 812, the method 800 includes entering the power saving mode (802).

In various examples, a controller (e.g., the controller 106, 306, 606) of the electronic device performs the method 800. For example, the controller causes the wireless charger to enter the power saving mode responsive to a determination that the switch is disengaged. The controller detects a change in the switch. For example, responsive to the switch engaging, the controller receives a signal. Responsive to the signal, the controller causes the wireless charger to enter the standby mode. The controller determines whether the peripheral device is compatible with the wireless charger, as described above with respect to FIG. 3. Responsive to a determination that the peripheral device is not compatible with the wireless charger, the controller causes the wireless controller to enter the power saving mode. Responsive to a determination that the peripheral device is compatible with the wireless charger, the controller causes the wireless charger to enter a charging mode. Responsive to detecting another change in the switch, the controller causes the wireless charger to enter the power saving mode.

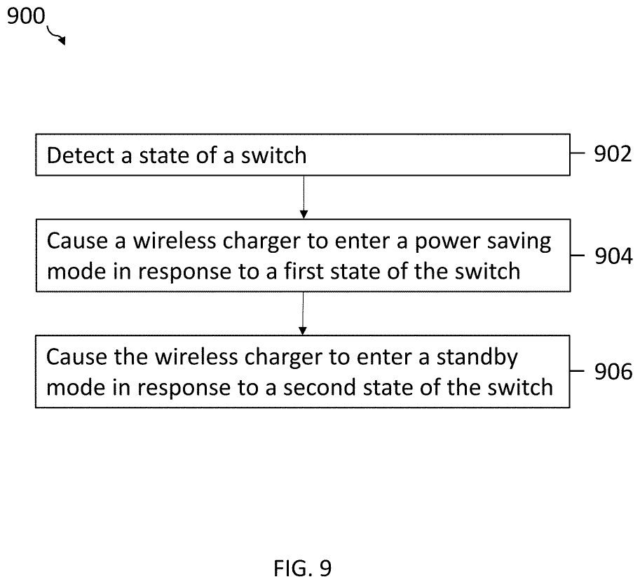

Referring now to FIG. 9, a flow diagram of a method 900 for adjusting the charging mode of a wireless charger (e.g., the wireless charger 110, 310, 610) is depicted, in accordance with various examples. The method 900 is performed by the electronic device 102, 302, 602, for example. The method 900 includes detecting a state of a switch (e.g., the switch 612) (902). The method 900 also includes causing the wireless charger to enter a power saving mode in response to a first state of the switch (904). Additionally, the method 900 includes causing the wireless charger to enter the standby mode in response to a second state of the switch (906).

In various examples, a controller (e.g., the controller 106, 306, 606) of the electronic device performs some or all of the method 900. For example, the controller detects the state of the switch. As described above with respect to FIG. 8, the controller determines that the switch is disengaged responsive to a lack of a signal and determines that the switch is engaged responsive to receipt of a signal. In response to detecting that the state of the switch indicates a first state, the controller causes the wireless charger to enter the power saving mode. In response to detecting that the state of the switch indicates a second state, the controller causes the wireless charger to enter the standby mode. In some examples, the first state indicates that the switch is disengaged, and the second state indicates that the switch is engaged.

In some examples, responsive to the standby mode, the controller detects a signal via a wireless transceiver (not explicitly shown) of the electronic device. In response to detecting the signal, the controller determines whether the signal indicates a peripheral device (e.g., the peripheral device 104, 304, 604, 700) is a compatible device utilizing the techniques described above with respect to FIG. 3. In response to a determination that the peripheral device is a compatible device, the controller causes the wireless charger to enter a charging mode. In response to a determination that the peripheral device is an incompatible device, the controller causes the wireless charger to enter the power saving mode. In various examples, responsive to the charging mode, the controller detects a second signal via the wireless transceiver of the electronic device. In response to detecting the second signal, the controller causes the wireless charger to enter the power saving mode. For example, the second signal indicates that the charge level of the peripheral device exceeds the capacity threshold.

Unless infeasible, some or all of the blocks of the method 200, 400, 500, 800, 900 may be performed by the electronic device 102, 302, 602 concurrently or in different sequences and by circuity of the electronic device, machine-readable instructions, or a combination thereof. For example, the method 200, 400, 500, 800, 900 is implemented by machine-readable instructions stored to a storage device (not explicitly shown) of the electronic device, circuitry (some of which is not explicitly shown) of the electronic device, or a combination thereof. A controller (e.g., the controller 106, 306, 606) of the electronic device executes the machine-readable instructions to perform some or all of the method 200, 400, 500, 800, 900, for example. In another example, comparators couple to the controller, the wireless charger (e.g., the wireless charger 110, 310, 610), the detector (e.g., the detector 108, 608, the sensor 308), a mux, or some combination thereof. The comparators determine whether values are below or exceed particular thresholds, and the mux selects a path for power supplied to the wireless charger based on the outputs of the comparators, for example. In another example, the controller performs a block that occurs responsive to the outputs of the comparators. In another example, the controller performs a block that depends upon a state of a component after the state of the component is enabled.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein may be shown in exaggerated scale or in somewhat schematic form, and some details of certain elements may not be shown in the interest of clarity and conciseness. In some of the figures, in order to improve clarity and conciseness, a component or an aspect of a component may be omitted.

In the above description and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a wireless charger;
a detector; and
a controller to:
detect a peripheral device via the detector; and
in response to detecting the peripheral device via the detector, determine an operation mode of the wireless charger, the operation mode including a power saving mode, a standby mode, and a charging mode.

2. The electronic device of claim 1, wherein the detector is a switch, a sensor, or a combination thereof.

3. The electronic device of claim 1, wherein the peripheral device is a stylus, a mouse, a keyboard, a touchpad, or a combination thereof.

4. The electronic device of claim 1, wherein the charging mode includes a quick charge mode and a normal charge mode.

5. The electronic device of claim 1, wherein the power saving mode utilizes less power than the standby mode and the charging mode.

6. An electronic device, comprising:
a wireless charger;
a sensor; and
a controller to:
cause the wireless charger to enter a power saving mode;
detect a signal via the sensor; and
in response to detecting the signal, cause the wireless charger to enter a standby mode.

7. The electronic device of claim 6, wherein the sensor is a Hall effect sensor, a Hall effect switch, or a reed switch.

8. The electronic device of claim 6, wherein the wireless charger is powered off when in the power saving mode.

9. The electronic device of claim 6, wherein the controller is to:
detect another signal via a wireless transceiver of the electronic device; and
in response to detecting the another signal, determine whether the another signal indicates a charge level of a peripheral device is below a threshold;
in response to a determination that the another signal indicates that the charge level is below the threshold, cause the wireless charger to enter a quick charge mode; and
in response to a determination that the another signal indicates that the charge level exceeds the threshold, cause the wireless charger to enter a normal charge mode.

10. The electronic device of claim 9, wherein the controller is to:
detect a third signal via the wireless transceiver of the electronic device; and
in response to detecting the third signal, cause the wireless charger to enter the power saving mode.

11. An electronic device, comprising:
a wireless charger;
a switch; and
a controller to:
detect a state of the switch;
in response to detecting that the state of the switch indicates a first state, cause the wireless charger to enter a power saving mode; and
in response to detecting that the state of the switch indicates a second state, cause the wireless charger to enter a standby mode.

12. The electronic device of claim 11, wherein the switch engages upon contact and disengages upon discontinuation of the contact.

13. The electronic device of claim 11, wherein the first state indicates that the switch is disengaged and the second state indicates that the switch is engaged.

14. The electronic device of claim 11, wherein, responsive to the standby mode, the controller is to:
detect a signal via a wireless transceiver of the electronic device; and
in response to detecting the signal, determine whether the signal indicates a peripheral device is a compatible device;
in response to a determination that the peripheral device is a compatible device, cause the wireless charger to enter a charging mode; and
in response to a determination that the peripheral device is an incompatible device, cause the wireless charger to enter the power saving mode.

15. The electronic device of claim 14, wherein the controller is to:
detect a second signal via the wireless transceiver of the electronic device; and
in response to detecting the second signal, cause the wireless charger to enter the power saving mode.
